(19) United States
(12) Patent Application Publication
(10) Pub. No.: US 2019/0302766 A1
(43) Pub. Date: Oct. 3, 2019

(54) Black Box Data Recorder with Artificial Intelligence Processor in Autonomous Driving Vehicle

(71) Applicant: Micron Technology, Inc., Boise, ID (US)

(72) Inventors: Antonino Mondello, Messina (IT); Alberto Troia, Munich (DE)

(21) Appl. No.: 15/938,504

(22) Filed: Mar. 28, 2018

(51) Int. Cl. G05D 1/00; G06F 21/64; H04L 9/32; G06N 3/02; G05D 1/02; G07C 5/08

(52) U.S. Cl. CPC G05D 1/0088; G06F 21/64; H04L 9/3278; G06N 3/02; G07C 5/0808; G05D 1/0255; G05D 1/0257; G07C 5/085; G05D 1/0246

(57) ABSTRACT

A black box controller determines whether or not vehicle sensor data of an autonomous vehicle is to be recorded in a non-volatile storage device, based on a result from an artificial intelligence (AI) processor. For example, the AI processor analyzes the sensor data to detect an event of interest that is about to take place and/or has taken place, such as an imminent or impending collision or nearby collision involving the respective vehicle or other vehicle. In response to the AI processor detecting an event, the AI processor instructs the black box controller to store the vehicle sensor data to the non-volatile storage; and the sensor data collected for a time period leading to the event and/or during the event is selected and stored in the non-volatile storage. As a result, there are less writing operations to the non-volatile storage device that may have relatively limited endurance.

### FIELD OF THE TECHNOLOGY

At least some embodiments disclosed herein relate to autonomous vehicle technology and more particularly, but not limited to, black box data recorders in autonomous vehicles.

### BACKGROUND

Autonomous driving vehicles (ADV) typically include many sensors to perform autonomous/driverless operations. In the case of an accident, collision, or near collision involving such a vehicle, reviewing the sensor data recorded just prior to and/or during the accident may assist the determination of the cause of the accident, and/or whether there may have been a vehicle failure.

A storage device used in a black box for recording such data may has limited endurance. Thus, recording may be done in a low resolution, with a limited time of recording, a limited number of frames, and the data may be compressed.

A typical storage device does not contain a secure mechanism for the verification of the authenticity of the data stored in the storage device. As a result, the data stored on the black box storage device may be vulnerable to tempering.

### BRIEF DESCRIPTION OF THE DRAWINGS

The embodiments are illustrated by way of example and not limitation in the figures of the accompanying drawings in which like references indicate similar elements.

FIG. 1 illustrates an embodiment of an improved black box data recorder in an autonomous driving vehicle (AVD).

FIG. 2 illustrates another embodiment of an improved black box data recorder in an autonomous driving vehicle (AVD).

FIG. 3 illustrates a flow diagram of an improved black box data recorder in an autonomous driving vehicle (AVD).

### DETAILED DESCRIPTION

At least some embodiments disclosed herein provide improved black box data recorders in autonomous driving vehicles (AVD). Automakers may want to record vehicle sensor data of autonomous vehicles. However, extended recordings of data in non-volatile storage can be expensive; and many non-volatile storage technologies have limited endurance. Embodiments described herein provide an improved solution for recording vehicle sensor data generated immediately prior to, and possibly during, an event of interest (e.g., collision or near collision involving the respective vehicle or nearby vehicle).

In one embodiment, a volatile memory is provided within a vehicle to temporarily hold vehicle sensors data. A black box controller determines when the vehicle sensor data in the volatile memory is to be recorded in a non-volatile storage device. In one embodiment, an artificial intelligence (AI) processor analyzes the sensor data stored in the memory to detect an event of interest (e.g., imminent or impending collision or nearby collision involving the respective vehicle or other vehicle) that is about to take place and/or has taken place. In response to the AI processor detecting an event of interest, the AI processor instructs the black box controller to store the sensor data from the volatile memory to the non-volatile storage. As a result, there are less writing operations to the non-volatile storage device that may have relatively limited endurance.

The techniques described herein can also be used in areas beyond AVDs, including vehicles using driver assistance technologies, video-surveillance, and monitoring of harsh environments.

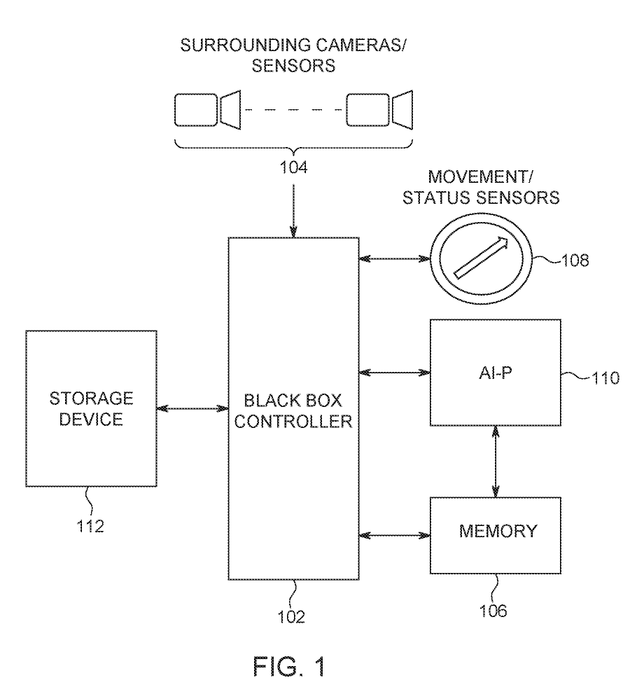

FIG. 1 illustrates an embodiment of an improved black box data recorder in an autonomous driving vehicle (AVD). In FIG. 1, a black box controller 102 receives a data stream of sensor data from multiple vehicle sensors 104 (e.g., surrounding cameras and other sensors). The vehicle sensor data may further include, but is not limited to camera data, radar data, lidar data, sonar data, laser measurements, tire pressure monitoring, and vehicle operation system data. The sensor data as referenced herein may also include vehicle operation data such as GPS data, inertial sensor data, autonomous vehicle computer signals and health status, etc.

The received data stream of the sensor data is initially held in a memory 106. In one embodiment, the memory 106 is volatile, such as a dynamic random access memory (DRAM), which requires continual power in order to refresh or maintain the data in the memory.

Alternatively or in combination, the sensor data can be held in a cyclic buffer implemented with volatile memory. The vehicle sensor data stored in the volatile buffer would not be compressed, or in an alternative embodiment could be compressed using a lossless compression or a less lossy compression—to preserve data quality.

When using a non-volatile cyclic buffer, the buffer may have a relatively smaller capacity (because of its high cost per memory unit), and be used to buffer a smaller, lesser quality version of the sensor data (lossy compression or a more lossy compression) to reduce the size of the data.

The cyclic buffers as referenced herein may also be circular buffers, circular queues, or ring buffers that include a data structure that use a single, fixed-size buffer as if it were connected end-to-end. The buffer structure readily buffers data streams. The reference to cyclic buffers as used herein references how the buffers are used. For example, the cyclic buffers are designed to be full as new data overwrites old data in a cyclic manner, ensuring that the buffer holds the latest set of data. The actual size of the first and/or the second cyclic buffers can vary within the scope of the invention. The actual number of cyclic buffers provided within a black box recorder may also vary within the scope of the invention.

Movement/status sensors 108 of the ADV send signals to the Black Box Controller, when the movement/status sensors 108 detect a variation, or are triggered or activated. The movement/status sensors 108 may include one or more of inertia sensors, acceleration sensors, sudden activation of the braking system, failure of the engine or other components within the ADV, signals from the Advanced driver assistance systems (ADAS) or an autonomous computer that indicates an accident/collision or near collision. In response to the data from the sensors (104) and/or the movement/status sensors 108, an artificial intelligence (AI) processor 110 analyzes the data stream of sensor data stored in the memory 106 to determine if an event of interest is about to happen and/or has occurred; and in response to the identification of the event based on the analysis of the AP processor 110, the black box controller 102 transfers the sensor data to a non-volatile storage device 112 for storage. For example, the AI processor 110 analyzes the sensor data stored in the memory 106 to determine if the sensor data indicates and/or predicts a collision or near collision involving the respective vehicle or nearby vehicle is imminent or impending.

In response to the AI processor 110 determining the data stream of sensor data indicates such an event is about to occur and/or has occurred, the AI processor 110 signals the Black Box Controller 102 to have sensor data generated/received immediately prior to, and possibly during the event, copied from the system memory 106 to the non-volatile storage device 112. With the data stream of sensor data relevant to the event stored in the non-volatile storage device 112, the sensor data can be later retrieved in an analysis of a possible cause of the event.

By using the AI processor 110 to analyze the sensor data and thus selectively determine when sensor data should be stored in the non-volatile storage device 112, endurance issues related to non-volatile storage are at least partially addressed by resulting in less write operations to the non-volatile storage device 112. With less write operations, higher quality sensor data (e.g., increasing the resolution, the frame rate) can be stored in the storage device 112.

In one embodiment, the AI processor 110 includes a neural network trained to understand and/or determine whether the sensor data indicates an imminent or impending event of interest, such as a collision, nearby collision, or impact involving the vehicle or a nearby vehicle, and whether the event warrants having the sensor data written in the non-volatile storage device 112. For example, using machine learning techniques and/or pattern recognition techniques, an AI model can be established, e.g., from training examples and used by the AI processor 110 to perform some tasks, such as making a decision of whether or not to record the sensor data in the storage device 112.

In one embodiment, the AI processor 110 utilizes an AI model (e.g., an artificial neural network) in making its decisions of whether to have the sensor data saved in the storage device 112. The AI model can be created based on known decisions for prior sensor data. For example, sensor data may be used as input to train an AI model that has parameters (e.g., the weights of the neurons in the artificial neural network, the connectivity of the network, the response functions of the neurons); and the parameters are adjusted during the training so that decisions/predictions made using sensor data best matches with the known recording decisions. The AI model and the parameters as a whole can be used in the AI processor 110 to make the recording decisions (or predictions of events of interest) based on the real time sensor data.

For example, the sensor data used as input to train the AI model can be the recorded data from past road trips; and the known decisions may be obtained from human reviewers of the recorded data in identifying events of interest and/or the decisions to record data leading to the events of interest. For example, recorded camera and sensor data may be played back to a human operator, which indicates when the human operator would want to have stored the sensor data. For example, when a car is running in a test mode, a safety driver may generate real time input to indicate when to record (e.g., when the safety driver sees an event of interest for recording). Past recordings that lead to accidents can also be used (e.g., the sensor data that was seen before an actual accident).

In some instances, the AI processor may make decisions in real-time based on a set of rules. For example, the AI processor 110 may recognizes objects and in response use predetermined rules to make recording decisions, where the rules specifies what spatial and motion relations among the objects and the vehicle should trigger the recording of the sensor data in storage device 112 (and when not to save the sensor data from the memory (106) to the storage device 112).

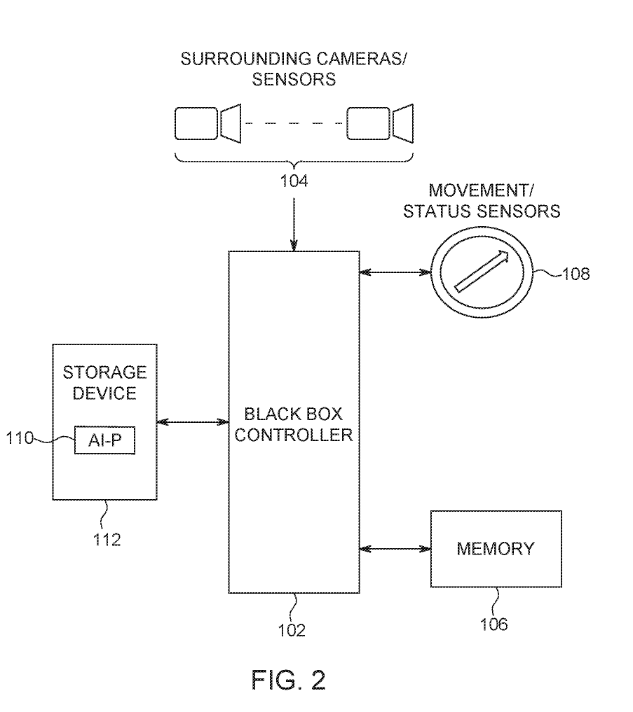

FIG. 2 illustrates another embodiment of an improved black box data recorder in an autonomous driving vehicle (AVD), wherein the AI processor 110 is integrated within the non-volatile storage device 112, providing a sub-system within the improved black box data recorder.

In some implementations, the storage device 112 of FIG. 1 or FIG. 2 can not only record the sensor data, but also create authenticity verification data that can be used to verify the authenticity of the sensor data stored in the storage device 112. For example, a secret key can be used to sign a hash of the stored sensor data to generate a signature. To verify whether the sensor data in the storage device 112 has been altered, the secret key can be applied to a hash of the current data stored in the storage device 112 to generate a current signature for comparison with the signature created at the time of the recordation of the sensor data. If the signatures do not agree with each other, the recorded sensor data has been altered.

In general, a symmetric cryptographic approach or an asymmetric cryptographic approach can be used to verify the authenticity of the sensor data stored in the storage device 112.

The symmetric approach uses the same secret key for the creating of the signature and during the verification of the signature. The secret key can be shared among authorized parties in a factory environment and/or self-generated by using a physical unclonable function (PUF) of the storage device 112 in conjunction with a freshness mechanism and a Message Authenticated Code (MAC) algorithm. To verify the signature, an authorized party uses the same MAC algorithm with the secret key.

The asymmetric approach uses a pair of public key and private key of the storage device 112, which key pair can be generated using a physical unclonable function (PUF) of the storage device 112, in conjunction with a freshness mechanism and a digital signature algorithm to produce a signature. Examples of digital signature algorithms include the digital standard signature (DSS) or one of its variants like the Elliptic Curve Digital Signature Algorithm (ECDSA) as defined in a National Institute of Standards and Technology (NIST) standard (e.g., Federal Information Processing Standards (FIPS) 186-4). The storage device 112 uses the private key to create a digital signature on data set stored in the storage device 112; and the authenticity of the digital signature can be verified using the public key.

Examples of the indicators used in the freshness mechanism include the result of a monotonic counter that is increased each time the signature output is generated, a time stamp, a nonce, etc.

Further details and examples of techniques to generate a unique key using PUF can be found in U.S. patent application Ser. No. 15/853,498, filed Dec. 22, 2017 and entitled “Physical Unclonable Function using Message Authentication Code”, the disclosure of which is hereby incorporated herein by reference.

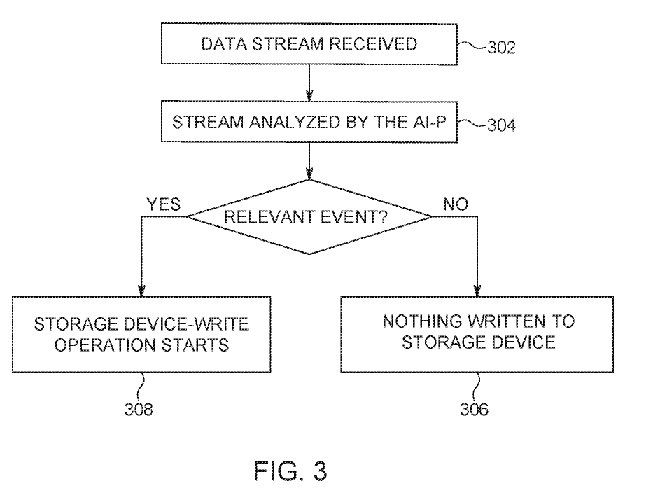

FIG. 3 illustrates a flow diagram of an improved black box data recorder in an autonomous driving vehicle (AVD). As described above, initially a data stream of sensor data is received 302. The vehicle sensor data may include, but is not limited to camera data, radar data, lidar data, sonar data, laser measurements, tire pressure monitoring, and vehicle operation system data. The vehicle sensor data as referenced herein may also include vehicle operation data such as GPS data, inertial sensor data, autonomous vehicle computer signals and health status, etc.

The data stream of sensor data is analyzed by the AI processor (as trained via a neural network) to determine if a relevant event is imminent or impending 304. For example, the AI processor 110 analyzes the sensor data stored in the memory 106 to determine if the sensor data indicates whether or not a collision or nearby collision is imminent/impending. The sensor data analyzed may include data from the movement/status sensors 108, such as one or more of inertia sensors, acceleration sensors, sudden activation of the braking system, failure of the engine or other components within the ADV, signals from the Advanced driver assistance systems (ADAS) or an autonomous computer that indicates an accident/collision or near collision. In an alternative embodiment, the AI processor may analyze the data from the sensors 104 without the data from the movement/status sensors 108.

If the AI processor determines that no relevant event is imminent or about to occur, no signal is sent to the black box controller 306 and/or the storage device 112 for the recording of recent sensor data from the sensors 104 and/or 108. If the AI processor determines a relevant event is imminent (e.g., a collision or nearby collision is likely), the black box controller 102 and/or the storage device 112 receives a notification to store the data stream of sensor data in the non-volatile storage device 112 and write operations to the non-volatile storage device begin 308.

In one embodiment, the volatile memory 106 could be implemented as memory of an onboard computer system installed in the vehicle, outside of a black box recorder that includes the storage device 112. The black box recorder may be configured with ports to be connected to the onboard computer. The black box controller 102 may or may not be in the recorder. In one embodiment, a CPU or processor of an onboard computer may serve as the black box controller, and/or the AI processor 110 can be implemented via software on the CPU with hardware acceleration (e.g., using a graphical processing unit (GPU) or other AI specific hardware). In some implementations, the black box recorder for intelligent recording functions and the onboard computer for autonomous driving functions may share software and/or hardware in processing the sensor data, such as camera and/or video data from the sensors 104.

The Non-volatile storage device 112 may be implemented via various techniques, such as memory cells in an integrated circuit. The storage media of the storage device 112 is non-volatile in that no power is required to maintain the data/information stored in the non-volatile storage media, which data/information can be retrieved after the non-volatile storage media is powered off and then powered on again. The memory cells may be implemented using various memory/storage technologies, such as NAND gate based flash memory, phase-change memory (PCM), magnetic memory (MRAM), resistive random-access memory, and 3D XPoint™, such that the storage device 112 is non-volatile and can retain data stored therein without power for days, months, and/or years.

In one embodiment, the storage device 102 can include cross point storage (e.g., 3D XPoint™ memory). A cross point memory device uses transistor-less memory elements, each of which has a memory cell and a selector that are stacked together as a column. Memory element columns are connected via two perpendicular lays of wires, where one lay is above the memory element columns and the other lay below the memory element columns. Each memory element can be individually selected at a cross point of one wire on each of the two layers. Cross point memory devices are fast and non-volatile and can be used as a unified memory pool for processing and storage.

The storage device 112 communications with the black box controller 102 may occur using a communication channel, which may use a PCIe protocol, NVMe protocol, or other communication protocols. The black box controller 102 and the storage device 112 can be configured to communicate with each other using data storage management and usage commands.

The black box controller 102 and/or a separate controller of the storage device 112 may run firmware to perform operations responsive to communications. Firmware in general is a type of computer program that provides control, monitoring and data manipulation of engineered computing devices. The firmware of the storage device or the black box controller may control the operations of operating the storage device, such as storing and accessing data, performing power management tasks, etc.

The memory 106 may use volatile Dynamic Random-Access Memory (DRAM) for the holding of data stream sensor data and possibly instructions used by the controller 102 to improve the computation performance of the controller 102 DRAM is volatile in that it requires power to maintain the data/information stored therein, which data/information is lost immediately or rapidly when the power is interrupted.

Volatile DRAM typically has less latency than non-volatile storage media, but loses its data quickly when power is removed. Thus, it is advantageous to use the volatile DRAM to temporarily store instructions and data used for the controller 102 in its current computing task to improve performance. In some instances, the volatile DRAM can be replaced with volatile Static Random-Access Memory (SRAM) that uses less power than DRAM in some applications.

In this description, various functions and operations may be described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor or microcontroller, executing sequences of instructions contained in a memory, such as ROM, volatile RAM, non-volatile memory, or other media as described herein.

A tangible, non-transitory computer storage medium can be used to store software and data which, when executed by a data processing system, causes the system to perform various methods. The executable software and data may be stored in various places including for example volatile RAM, non-volatile memory and/or media as described herein. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in their entirety prior to the execution of the applications. Alternatively, portions of the data and instructions can be obtained dynamically, just in time, when needed for execution. Thus, it is not required that the data and instructions be on a machine-readable medium in their entirety at a particular instance of time.

Examples of computer-readable storage media include, but are not limited to, recordable and non-recordable type media such as volatile and non-volatile memory devices, read only memory (ROM), random access memory (RAM), flash memory devices, floppy and other removable disks, magnetic disk storage media, and optical storage media (e.g., Compact Disk Read-Only Memory (CD ROM), Digital Versatile Disks (DVDs), etc.), among others. The instructions may be embodied in a transitory medium, such as electrical, optical, acoustical or other forms of propagated signals, such as carrier waves, infrared signals, digital signals, etc. A transitory medium is typically used to transmit instructions, but not viewed as capable of storing the instructions.

Although some of the drawings illustrate a number of operations in a particular order, operations that are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

The above description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A data recording apparatus in an autonomous driving vehicle, the apparatus comprising:
a non-volatile storage device to store vehicle sensor data received from a set of sensors and cameras of the autonomous driving vehicle;
a black box controller coupled to the storage device; and
an artificial intelligence (AI) processor coupled to the black box controller, the AI processor to analyze the vehicle sensor data received from the set of sensors and cameras of the autonomous driving vehicle, to identify an event of interest, and to instruct the black box controller to store the vehicle sensor data related to the event in the storage device in response to detecting the event of interest.

2. The autonomous driving vehicle of claim 1, comprising the data recording apparatus, wherein the event is an impending collision involving the autonomous driving vehicle.

3. The autonomous driving vehicle of claim 2, wherein autonomous driving of the vehicle is based on the vehicle sensor data received from the set of sensors and cameras.

4. The autonomous driving vehicle of claim 2, wherein at a time of the event the autonomous driving vehicle is operating in an autonomous driving mode.

5. The autonomous driving vehicle of claim 2, wherein the vehicle sensor data comprises data collected from at least one of:
a camera;
an infrared camera;
a sonar;
a radar; and
a lidar.

6. The data recording apparatus of claim 1, wherein the vehicle sensor data is stored in the storage device with a signature.

7. The data recording apparatus of claim 6, wherein the signature includes a hash of the vehicle sensor data signed using symmetric cryptography or asymmetric cryptography.

8. The data recording apparatus of claim 7, wherein a secret applied to generate the signature is based on a physical unclonable function (PUF) of the autonomous driving vehicle.

9. The data recording apparatus of claim 8, wherein the signature is generated based on a freshness factor.

10. A method of recording sensor data in an autonomous driving vehicle, the method comprising:
receiving vehicle sensor data from a set of sensors and cameras of the autonomous driving vehicle;
analyzing, by an artificial intelligence (AI) processor, the vehicle sensor data received from the set of sensors and cameras of the autonomous driving vehicle, to identify an event of interest; and
in response to the event of interest being identified by the AI processor, storing in a non-volatile storage device the vehicle sensor data related to the event of interest.

11. The method of claim 10, wherein the event is an impending collision involving the autonomous driving vehicle.

12. The method of claim 11, further comprising:
performing autonomous driving of the vehicle based on the vehicle sensor data received from the set of sensors and cameras.

13. The method of claim 12, wherein at a time of the event the autonomous driving vehicle is operating in an autonomous driving mode.

14. The method of claim 11, wherein the vehicle sensor data comprises data collected from at least one of:
a camera;
an infrared camera;
a sonar;
a radar; and
a lidar.

15. The method of claim 10, further comprising:
generating a signature in the storage device for the vehicle sensor data stored in the storage device.

16. The method of claim 15, wherein the signature includes a hash of the vehicle sensor data signed using symmetric cryptography or asymmetric cryptography.

17. The method of claim 16, wherein a secret applied to generate the signature is based on a physical unclonable function (PUF) of the autonomous driving vehicle.

18. The method of claim 17, wherein the signature is generated based on a freshness factor.

19. A non-transitory machine readable medium having stored thereon a set of instructions which, when executed by a computing apparatus, cause the computing apparatus to perform a method, the method comprising:
receiving vehicle sensor data from a set of sensors and cameras of an autonomous driving vehicle;
analyzing, by an artificial intelligence (AI) processor, the vehicle sensor data received from the set of sensors and cameras of the autonomous driving vehicle, to identify an event of interest; and
in response to the event of interest being identified by the AI processor, storing in a non-volatile storage device the vehicle sensor data related to the event of interest.

20. The machine readable medium of claim 19, wherein the method further comprises:
performing autonomous driving based on the vehicle sensor data received from the set of sensors and cameras.
